(19) United States
(12) Patent Application Publication
(10) Pub. No.: US 2009/0142112 A1
(43) Pub. Date: Jun. 4, 2009

(54) PHASE CHANGE INK IMAGING COMPONENT HAVING COMPOSITE OUTER LAYER

(75) Inventors: David J. Gervasi, Pittsford, NY (US); Santokh S. Badesha, Pittsford, NY (US); James E. Williams, Penfield, NY (US); Paul J. McConville, Webster, NY (US)

Correspondence Address: PILLSBURY WINTHROP SHAW PITTMAN, LLP;XEROX CORPORATION, P.O. BOX 10500, MCLEAN, VA, 22102, US

(73) Assignee: Xerox Corporation, Norwalk, CT (US)

(21) Appl. No.: 11/948,110

(22) Filed: Nov. 30, 2007

(51) Int. Cl. G03G 15/20

(52) U.S. Cl. 399/328

(57) ABSTRACT

An offset printing apparatus for transferring and optionally fixing a phase change ink onto a print medium including a) a phase change ink application component for applying a phase change ink in a phase change ink image to an imaging member; b) an imaging member for accepting, transferring and optionally fixing the phase change ink image to the print medium, the imaging member having: i) an imaging substrate, and thereover ii) an outer coating comprising a polymer matrix with an oleophobic resin, a fluoropolymer lubricant, and a first additive; and c) a release agent management system for supplying a release agent to the imaging member, wherein an amount of release agent needed for transfer and optionally fixing the phase change ink image is reduced.

### CROSS REFERENCE TO RELATED APPLICATIONS

Attention is directed to U.S. application Ser. No. ______ (Attorney Docket No. 20070152Q), filed ______, entitled “Ink-Jet Printer Using Phase Change Ink for Direct on Paper Printing.”

### BACKGROUND

Herein is disclosed a phase change ink imaging/transfix component and layers thereof, for use in offset printing or ink jet printing apparatuses. In embodiments, the imaging component is responsible for accepting an ink image and a) transfer of the ink image (imaging member), or b) transfer and fusing (transfix member) of the developed image to a print medium or copy substrate. The phase change imaging/transfix component can be used in combination with phase change inks such as solid inks.

Ink jet printing systems using intermediate transfer, transfix or transfuse members are well known, such as that described in U.S. Pat. No. 4,538,156. Generally, the transfix printing or intermediate transfer member is employed in combination with a printhead. A final receiving surface or print medium is brought into contact with the transfix printing surface after the image has been placed thereon by the nozzles of the printhead. The image is then transferred and fixed to a final receiving surface.

More specifically, the phase-change ink transfer printing process begins by first applying a thin liquid, such as, for example, silicone oil, to an imaging member surface. The solid or hot melt ink is placed into a heated reservoir where it is maintained in a liquid state. This highly engineered ink is formulated to meet a number of constraints, including low viscosity at jetting temperatures, specific visco-elastic properties at component-to-media transfer temperatures, and high durability at room temperatures. Once within the printhead, the liquid ink flows through manifolds to be ejected from microscopic orifices through use of proprietary piezoelectric transducer (PZT) printhead technology. The duration and amplitude of the electrical pulse applied to the PZT is very accurately controlled so that a repeatable and precise pressure pulse can be applied to the ink, resulting in the proper volume, velocity and trajectory of the droplet. Several rows of jets, for example four rows, can be used, each one with a different color. The individual droplets of ink are jetted onto the liquid layer on the imaging member. The imaging member and liquid layer are held at a specified temperature such that the ink hardens to a ductile visco-elastic state.

After depositing the image, a print medium is heated by feeding it through a preheater and into a nip formed between the imaging member and a pressure member, either or both of which can also be heated. A high durometer synthetic pressure member is placed against the imaging member in order to develop a high-pressure nip. As the imaging member rotates, the heated print medium is pulled through the nip and is pressed against the deposited ink image with the help of a pressure member, thereby transferring the ink to the print medium. The pressure member compresses the print medium and ink together, spreads the ink droplets, and fuses the ink droplets to the print medium. Heat from the preheated print medium heats the ink in the nip, making the ink sufficiently soft and tacky to adhere to the print medium. When the print medium leaves the nip, stripper fingers or other like members, peel it from the printer member and direct it into a media exit path.

To optimize image resolution, the transferred ink drops should spread out to cover a predetermined area, but not so much that image resolution is compromised or lost. The ink drops should not melt during the transfer process. To optimize printed image durability, the ink drops should be pressed into the paper with sufficient pressure to prevent their inadvertent removal by abrasion. Finally, image transfer conditions should be such that nearly all the ink drops are transferred from the imaging member to the print medium. Therefore, it is desirable that the imaging member have the ability to transfer the image to the media sufficiently.

The imaging member is multi-functional. First, the ink jet printhead prints images on the imaging member, and thus, it is an imaging member. Second, after the images are printed on the imaging member, they can then be transfixed or transfused to a final print medium. Therefore, the imaging member provides a transfix or transfuse function, in addition to an imaging function.

In duplex machines, maintenance oils, release oils, release agents, fuser oils, fuser agents, and the like, are normally used in order to provide appropriate transfix function. However, is can be difficult to control the amount of release agent on the pressure member and the imaging/transfix member. The oil level on the pressure member, as transferred by contact with the imaging/transfix member or by carryout in an inked portion of the printed image, is a major cause of ghosting and duplex drop out.

Much of duplex print quality in phase change ink printers is driven by oil levels, both on the pressure member and on the imaging member. While many coatings may be oleophobic, they do not have the physical integrity to withstand prolonged printing cycles, or duplex cycling. Therefore, it is desired to provide a composite coating, which combines oleophobic properties with very good physical properties such as toughness and adhesion to the substrate.

Several coatings for the imaging member have been suggested.

U.S. Pat. No. 7,222,954 discloses a phase change ink apparatus having an imaging component including a substrate, an optional intermediate layer, and an outer coating having an elastomer of monomers selected from the group consisting of halogen monomers, polyorganosiloxane monomers, and mixtures thereof.

U.S. Pat. No. 6,910,765 discloses a phase change ink apparatus having an imaging component including a substrate, an optional intermediate layer, and an outer coating having a haloelastomer having pendant chains covalently bonded to the backbone of the haloelastomer.

U.S. Pat. No. 7,234,806 discloses a phase change ink apparatus having an imaging component including a substrate, an optional intermediate layer, and an outer coating having a fluorosilicone material.

U.S. Pat. No. 6,843,559 discloses a phase change ink apparatus having an imaging component including a substrate, an optional intermediate layer, and an outer coating having a latex fluoroelastomer material.

U.S. Pat. No. 6,932,470 discloses a phase change ink apparatus having an imaging component including a substrate, an optional intermediate layer, and an outer coating having a mica-type silicate material.

U.S. Pat. No. 6,648,467 discloses a phase change ink apparatus having an imaging component including a substrate, an optional intermediate layer, and an outer coating having a silicone material and Q-resin.

U.S. Pat. No. 6,939,000 discloses a phase change ink apparatus having an imaging component including a substrate, an optional intermediate layer, and an outer coating having a polymer blend of a first polymer and a second polymer different from the first polymer.

It is desired to provide a multi-functional imaging/transfix member for use with phase change ink printing machines, including duplex machines, which has the ability to receive a phase change ink image, and transfer or transfer and fuse the image to a print medium, without causing ghosting and duplex drop out. It is desired that the transfix member when having heat associated therewith, be thermally stable for conduction for fusing or fixing, and adhere appropriately to the substrate of the transfix component.

### SUMMARY

Included herein, in embodiments, are an offset printing apparatus for transferring and optionally fixing a phase change ink onto a print medium comprising: a) a phase change ink application component for applying a phase change ink in a phase change ink image to an imaging member; b) an imaging member for accepting, transferring and optionally fixing the phase change ink image to the print medium, the imaging member comprising: i) an imaging substrate, and thereover ii) an outer coating comprising a polymer matrix comprising an oleophobic resin, a fluoropolymer lubricant, and a first additive; and c) a release agent management system for supplying a release agent to the imaging member, wherein an amount of release agent needed for transfer and optionally fixing the phase change ink image is reduced.

### BRIEF DESCRIPTION OF THE DRAWINGS

The above embodiments will become apparent as the following description proceeds upon reference to the drawings, which include the following figures:

FIG. 1 is an illustration of an embodiment herein, and includes a transfer printing apparatus using an imaging/transfix member in the form of a drum.

FIG. 2 is an enlarged view of an embodiment of an imaging/transfix printing drum having a substrate and an outer composite layer thereon.

FIG. 3 is an enlarged view of an embodiment of an imaging/transfix printing drum having a substrate, and optional intermediate layer, and an outer composite layer thereon.

FIG. 4 is a Table showing the four corners coatings and five other coatings.

### DETAILED DESCRIPTION

Herein is disclosed an offset printing apparatus useful with phase-change inks such as solid inks, and comprising a coated imaging/transfix member capable of accepting, transferring or transferring and fixing an ink image to a print medium. In embodiments, the current imaging/transfix member can be used in duplex machines. The process of transferring and fixing by the same component is sometimes referred to as “transfix” or “transfuse.” If the imaging member is used in combination with separate fusing station, then the member is termed “imaging member” herein. If the member is responsible for both transfer and fixing, then the member is referred to as “transfix member” herein. For general discussions of both members, the term “imaging/transfix member” will be used throughout.

The imaging/transfix member can be a roller such as a drum, or a film component such as a film, sheet, belt or the like. In embodiments, the imaging/transfix member is an imaging/transfix drum. In embodiments, the imaging/transfix member comprises a substrate and an outer layer comprising a composite or polymer matrix. In an alternative embodiment, the imaging/transfix member comprises a substrate, an optional intermediate layer, and outer layer comprising a composite or polymer matrix. The composite or polymer matrix comprises an oleophobic resin, a fluoropolymer lubricant and a reinforcer(s) and/or filler(s). The substrate, intermediate layer, and/or outer layer can further comprise fillers dispersed or contained therein. The composite coating or polymer matrix coating improves the control of the oil level on the imaging/transfix member surface, and in addition, adhesion of the coating to the substrate member is improved. The resulting matrix coating has high lubricity and low surface energy from the fluoropolymer lubricant, has overall high wear resistance due to the oleophobic resin component and optional additives (such as reinforcers), and has a smooth surface and superior physical properties due to the additives such as reinforcer(s) and/or inorganic filler(s).

The details of embodiments of phase-change ink printing processes are described in the patents referred to above, such as U.S. Pat. Nos. 5,502,476; 5,389,958; 6,908,664, and 6,196,675 B1, the disclosures of each of which are hereby incorporated by reference in their entirety.

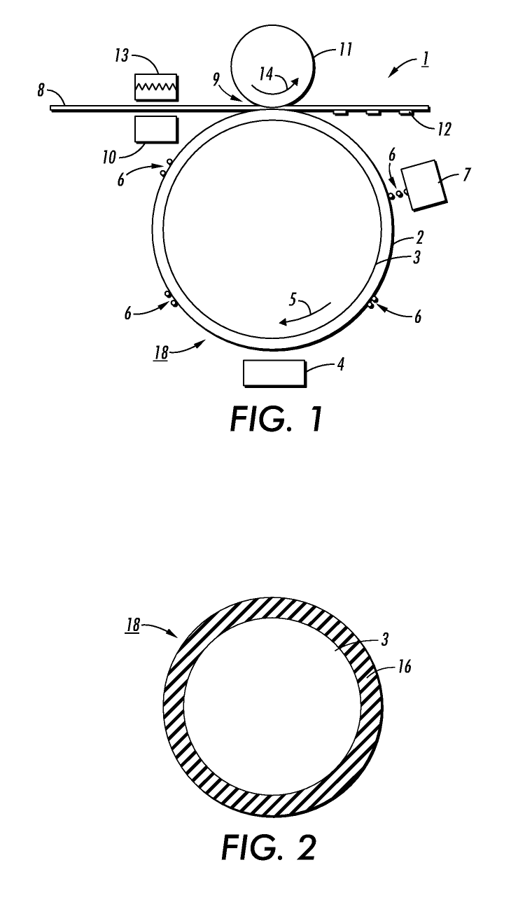

Referring to FIG. 1, offset printing apparatus 1 is demonstrated to show transfer of an ink image from the imaging member to a final printing medium or receiving substrate. As the imaging member 18 turns in the direction of arrow 5, a liquid surface 2 is deposited on imaging/transfix member 18. The imaging/transfix member 18 is depicted in this embodiment as a drum member. However, it should be understood that other embodiments can be used, such as a belt member, film member, sheet member, or the like. The liquid layer 2 is deposited by an applicator 4 that may be positioned at any place, as long as the applicator 4 has the ability to make contact and apply liquid surface 2 to imaging/transfix member 18.

The ink used in the printing process can be a phase change ink, such as, for example, a solid ink. The term “phase change ink” means that the ink can change phases, such as a solid ink becoming liquid ink or changing from solid into a more malleable state. Specifically, in embodiments, the ink can be in solid form initially, and then can be changed to a molten state by the application of heat energy. The solid ink may be solid at room temperature, or at about 25° C. The solid ink may possess the ability to melt at relatively high temperatures above from about 85° C. to about 150° C. The ink is melted at a high temperature and then the melted ink 6 is ejected from printhead 7 onto the liquid layer 2 of imaging/transfix member 18. The ink is then cooled to an intermediate temperature of from about 20° C. to about 80° C., or about 72° C., and solidifies into a malleable state in which it can then be transferred onto a final receiving substrate 8 or print medium 8.

The ink has a viscosity of from about 5 to about 30 centipoise, or from about 8 to about 20 centipoise, or from about 10 to about 15 centipoise at about 140° C. The surface tension of suitable inks is from about 23 to about 50 dynes/cm. Examples of suitable inks for use herein include those described in U.S. Pat. Nos. 4,889,560; 5,919,839; 6,174,937; and 6,309,453, the disclosure each of which are hereby incorporated by reference in their entirety.

Some of the liquid layer 2 is transferred to the print medium 8 along with the ink. A typical thickness of transferred liquid is about 100 angstroms to about 100 nanometer, or from about 0.1 to about 200 milligrams, or from about 0.5 to about 50 milligrams, or from about 1 to about 10 milligrams per print medium.

Suitable liquids that may be used as the imaging/transfix print liquid surface 2 include water, fluorinated oils, glycol, surfactants, mineral oil, silicone oil, functional oils, and the like, and mixtures thereof. Functional liquids include silicone oils or polydimethylsiloxane oils having mercapto, fluoro, hydride, hydroxy, and the like functionality.

Feed guide(s) 10 and 13 help to feed the print medium 8, such as paper, transparency or the like, into the nip 9 formed between the pressure member 11 (shown as a roller), and imaging/transfix member 18. It should be understood that the pressure member can be in the form of a belt, film, sheet, or other form. In embodiments, the print medium 8 is heated prior to entering the nip 9 by heated feed guide 13. When the print medium 8 is passed between the transfix printing medium 3 and the pressure member 11, the melted ink 6 now in a malleable state is transferred from the imaging/transfix member 18 onto the print medium 8 in image configuration. The final ink image 12 is spread, flattened, adhered, and fused or fixed to the final print medium 8 as the print medium moves between nip 9. Alternatively, there may be an additional or alternative heater or heaters (not shown) positioned in association with offset printing apparatus 1. In another embodiment, there may be a separate optional fusing station located upstream or downstream of the feed guides.

The pressure exerted at the nip 9 is from about 10 to about 1,000 psi, or about 500 psi, or from about 200 to about 500 psi. This is approximately twice the ink yield strength of about 250 psi at 50° C. In embodiments, higher temperatures, such as from about 72 to about 75° C. can be used, and at the higher temperatures, the ink is softer. Once the ink is transferred to the final print medium 8, it is cooled to an ambient temperature of from about 20° C. to about 25° C. Stripper fingers (not shown) may be used to assist in removing the print medium 8 having the ink image 12 formed thereon to a final receiving tray (also not shown).

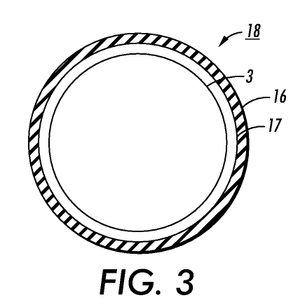

FIG. 2 demonstrates an embodiment herein, wherein imaging/transfix member 18 comprises substrate 15, having thereover outer coating 16.

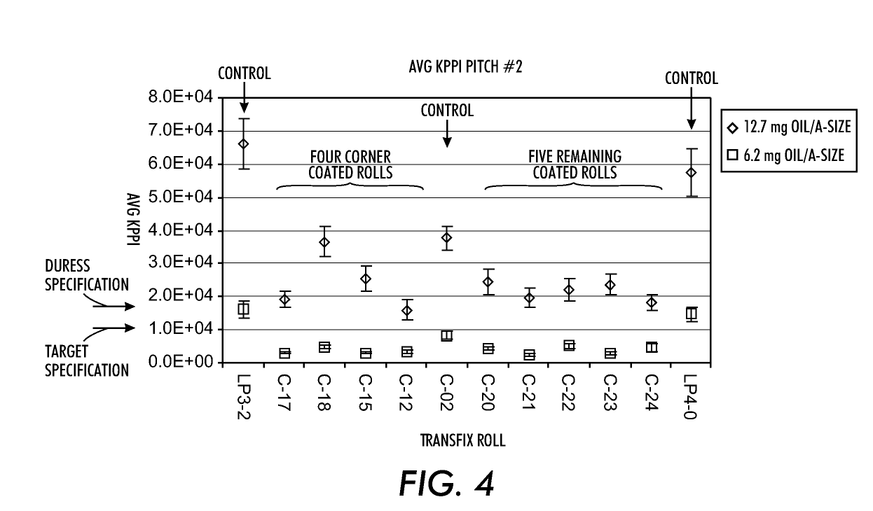

FIG. 3 depicts another embodiment herein. FIG. 3 depicts a three-layer configuration comprising a substrate 15, intermediate layer 17 positioned on the substrate 15, and outer layer 16 positioned on the intermediate layer 17. In embodiments, an outer liquid layer 2 (as described above) may be present on the outer layer 16.

The imaging/transfix member 18 includes an outer layer 16 comprising a polymer matrix comprising oleophobic resin, a fluoropolymer lubricant, and an additive.

An “oleophobic” resin is defined herein as a resin that lacks affinity for oil. It is the opposite of oleophilic. The resin does not necessarily impart oloephobicity. It might, but the resulting composition must be oleophobic. The oleophobic resin can be a fluoropolymer, a polyamide, a polyimide, polyamide-imide, or the like, or mixtures thereof. In embodiments, the oleophobic resin is polyamide-imide, such as solubilized polyamide-imide.

The oleophobic resin is present in the imaging outer layer in an amount of from about 1 to about 95, or from about 50 to about 95, or from about 75 to about 90 percent by weight of total solids. Total solids as used herein refers to the total amount by weight of elastomer, additional additives (such as fillers and/or reinforcers), or like solid materials.

A “fluoropolymer lubricant” is defined herein as a polymeric material having less than about 50 percent fluorine by weight. Examples include fluorinated ethylene propylene (FEP), polytetrafluoroethylene (FEP), perfluoroalkoxy (PFA), and mixtures thereof. The fluoropolymer lubricant is present in the outer coating in an amount of from about 1 to about 50 percent, or from about 5 to about 30 percent, or from about 5 to about 15 percent by weight of total solids.

The additive can be a reinforcer and/or a filler. A “reinforcer” as used herein is defined as any additive that imparts unto a composite polymer system an enhanced physical or chemical property not inherently present in the system prior to its addition. A “filler” as used herein is defined as a solid particulate additive that imparts unto a composite polymer system an enhanced physical or chemical property not inherently present in the system prior to its addition.

Examples of reinforcers include those selected from carbon reinforcers, ceramics, polymers, and the like, and mixtures thereof. Examples of carbon reinforcers include carbon black (such as N-990 thermal black, N330 and N10 carbon blacks, and the like), graphite, fluorinated carbon (such as ACCUFLUOR® or CARBOFLUOR®), and the like, and mixtures thereof. Examples of ceramic materials include aluminum nitrate, boron nitride, silicates such as zirconium silicates, silica, titania, alumina, and the like, and mixtures thereof. Examples of polymer reinforcers include polytetrafluoroethylene powder, polypyrrole, polyacrylonitrile (for example, pyrolyzed polyacrylonitrile), polyaniline, polythiophenes, and the like, and mixtures thereof. In embodiments, the additive is a reinforcer and is carbon black.

The filler can be a metals, metal oxides, doped metal oxides and the like, and mixtures thereof, and can include titanium dioxide, tin (II) oxide, aluminum oxide, indium-tin oxide, magnesium oxide, copper oxide, iron oxide, silica or silicon oxide, and the like, and mixtures thereof.

The additive is present in the substrate, optional intermediate layer, and/or outer layer in an amount of from about 1 to about 50, or from about 5 to about 30, or from about 5 to about 20 percent by weight of total solids in the layer.

The polymer matrix comprising a resin, fluoropolymer lubricant and additive is present in the outer coating in an amount of from about 5 to about 95, or from about 10 to about 40 percent by weight of total solids.

Also included in the outer coating can be solvents and optional fillers other than the reinforcer and/or filler, and further the layer can include dispersion agents, co-solvents, surfactants, and the like.

In embodiments, the thickness of the outer imaging layer is from about 1 to about 200, or from about 25 to about 100, or from about 25 to about 75 microns.

The substrate, optional intermediate layer, and/or outer layer, in embodiments, may comprise additives, such as those just described, dispersed therein.

The imaging/transfix member substrate can comprise any material having suitable strength for use as an imaging/transfix member substrate. Examples of suitable materials for the substrate include metals, rubbers, fiberglass composites, and fabrics. Examples of metals include steel, aluminum, nickel, and their alloys, and like metals, and alloys of like metals. The thickness of the substrate can be set appropriate to the type of imaging member employed. In embodiments wherein the substrate is a belt, film, sheet or the like, the thickness can be from about 0.5 to about 500 mils, or from about 1 to about 250 mils. In embodiments wherein the substrate is in the form of a drum, the thickness can be from about 1/32 to about 1 inch, or from about 1/16 to about ⅝ inch.

Examples of suitable transfix substrates include a sheet, a film, a web, a foil, a strip, a coil, a cylinder, a drum, an endless strip, a circular disc, a belt including an endless belt, an endless seamed flexible belt, an endless seamless flexible belt, an endless belt having a puzzle cut seam, a weldable seam, and the like.

In an optional embodiment, an intermediate layer may be positioned between the imaging/transfix substrate and the outer layer. Materials suitable for use in the intermediate layer include silicone materials, fluoroelastomers, fluorosilicones, ethylene propylene diene rubbers, and the like, and mixtures thereof. In embodiments, the intermediate layer is conformable and is of a thickness of from about 2 to about 60 mils, or from about 4 to about 25 mils.

In embodiments, the water contact angle is above about 100° C. The coating has a high wear resistance of from about 1 million to about 3 million prints. Moreover, the coating has a smooth surface, having a surface roughness Ra of less than about 5 microns.

The pressure member 11 is positioned on an opposite contact side from the imaging/transfix member 18. The pressure member may comprise a substrate and an outer polyurethane layer positioned on the substrate and may have a modulus of from about 8 to about 300 MPa, and a thickness of from about 0.3 to about 10 mm, and wherein the pressure exerted at the nip is from about 750 to about 4,000 psi.

The process for producing the outer coating includes cleaning the roll with isopropyl alcohol (IPA), followed by masking the journal ends. The roll may be flow-coated with one pass of coating using program #8 on flow coater, 120 rpm/60 rps using small pump on Ismatek. This can be followed by flash for about 15 minutes, and followed by oven cure: 400F, 15 minutes. The roll can be flipped on the coater to minimize end effects. The roll is then flow-coated with a second pass of coating, followed by air flash for about 15 minutes. This is followed by oven cure: 400F, 15 minutes, and is then cooled.

The following Examples further define and describe embodiments herein. Unless otherwise indicated, all parts and percentages are by weight.

### EXAMPLES

### Example 1

An aluminum roll was first cleaned with isopropyl alcohol (IPA), and the journal ends were masked. The roll was flow-coated with one pass of coating using program #8 on flow coater. The coating flow rate was set to 120 rpm/60 rps using a small pump on an Ismatek pump system. This was followed by ambient air flash for about 15 minutes, and followed by oven cure: 4000F, for about 15 minutes. The roll was reversed on the coater to minimize end effects. The roll was then flow-coated with a second pass of coating, followed by ambient air flash for about 15 minutes. This was followed by an oven cure at 400° F. for about 15 minutes. The roll was then cooled in ambient laboratory conditions and prepared for machine testing by the addition of the appropriate bearings.

Several coated rolls that were coated according to the procedure described above and with specific embodiments of the coating described above were placed in a solid ink printer and print quality performance was compared to that of several uncoated control rolls. The primary test response is Duplex Dropout (DDO), measured in KPPI (black pixels per inch). Duplex dropout is the number of un-transferred pixels left on the imaging drum after a duplex print cycle. The acceptable level of this particular defect is 16,000, while the target specification is 10,000. These numbers are based on customer acceptability of the print quality. The testing was conducted under low and high oil conditions. The data for the testing is shown in FIG. 3. The commercial formulation, XYLAN® 1404, manufactured by Whitford Worldwide Corporation, was used as a control coating formulation for comparison against to the uncoated roll. Then the 1404/D0842A was further modified by adding increasing amounts of either fluorinated ethylene propylene (FEP) or electrically conductive carbon black (CB) by the manufacturer. The rolls had an additional level of CB or FEP in the amount of 5-25 weight percent added to the original 1404/D0842A. The remaining coatings were combinations of the two additives within the compositional boundaries of the ‘four corners’ portion of the coating design.

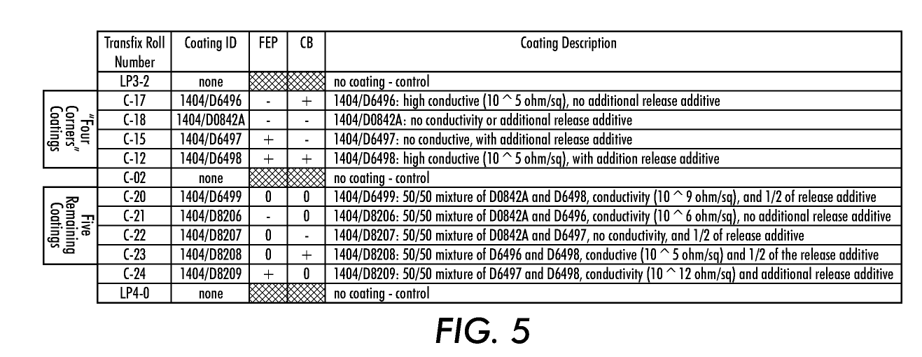

In the table in FIG. 4, a more complete description of the coating design is included, where a “+” refers to a maximum amount of the additive and the “−” refers to no additional additive. A “0” corresponds to an amount of additive in between the “−” and “+” levels of the respective additive. The corresponding roll number for each formulation is also given in the table. The Table is also added as an excel file at FIG. 4.

| | Transfix Roll | | | | |
|---|---|---|---|---|---|
| | Number | Coating ID | FEP | CB | Coating Description |
| | LP3-2 | none | | | no coating - control |
| “Four | C-17 | 1404/D6496 | − | + | 1404/D6496: high conductive (10\hat{ }5 ohm/sq), |
| Corners” | | | | | no additional release additive |
| coatings | C-18 | 1404/D0842A | − | − | 1404/D0842A: no conductivity or additional release additive |
| | C-15 | 1404/D6497 | + | − | 1404/D6497: no conductive, with additional release additive |
| | C-12 | 1404/D6498 | + | + | 1404/D6498: high conductive (10\hat{ }5 ohm/sq), |
| | | | | | with addition release additive |
| | C-02 | none | | | no coating - control |
| Five | C-20 | 1404/D6499 | 0 | 0 | 1404/D6499: 50/50 mixture of D0842A and D6498, conductivity |
| Remaining | | | | | (10\hat{ }9 ohm/sq), and ½ of release additive. |
| Coatings | C-21 | 1404/D8206 | − | 0 | 1404/D8206: 50/50 mixture of D0842A and D6496, conductivity |
| | | | | | (10\hat{ }6 ohm/sq), no additional release additive |
| | C-22 | 1404/D8207 | 0 | − | 1404/D8207: 50/50 mixture of D0842A and D6497, no conductivity, |
| | | | | | and ½ of release additive |
| | C-23 | 1404/D8208 | 0 | + | 1404/D8208: 50/50 mixture of D6496 and D6498, conductive |
| | | | | | (10\hat{ }5 ohm/sq) and ½ of the release additive |
| | C-24 | 1404/D8209 | + | 0 | 1404/D8209: 50/50 mixture of D6497 and D6498, conductivity |
| | | | | | (10\hat{ }12 ohm/sq) and additional release additive. |
| | LP4-0 | none | | | no coating - control |

The “four corners” or extremes of the matrix of coating formulations used to coat the rolls are designated C-17, C-18, C-15 and C-12. It has been demonstrated that coatings C-17 and C-12 reduce the Duplex dropout defect by as much as three times depending on the condition, when compared with the control, uncoated roll. The coating and the results of the testing of the five remaining coated rolls are contained within the boundaries of the “four corner” rolls. From the information in this particular test further optimization of the coating formulation can be realized.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. An offset printing apparatus for transferring and optionally fixing a phase change ink onto a print medium comprising:
a) a phase change ink application component for applying a phase change ink in a phase change ink image to an imaging member;
b) an imaging member for accepting, transferring and optionally fixing the phase change ink image to said print medium, the imaging member comprising:
i) an imaging substrate, and thereover
ii) an outer coating comprising a polymer matrix comprising an oleophobic resin, a fluoropolymer lubricant, and a first additive; and
c) a release agent management system for supplying a release agent to said imaging member, wherein an amount of release agent needed for transfer and optionally fixing said phase change ink image is reduced.

2. The offset printing apparatus of claim 1, wherein said oleophobic resin is selected from the group consisting of polyamide-imide and fluoropolymer.

3. The offset printing apparatus of claim 2, wherein said oleophobic resin is a solubilized polyamide-imide.

4. The offset printing apparatus of claim 1, wherein said fluoropolymer lubricant is selected from the group consisting of perfluoroalkoxy, tetrafluoroethylene, fluorinated ethylene propylene.

5. The offset printing apparatus of claim 1, wherein said first additive is a reinforcer selected from the group consisting of carbon reinforcers, ceramics, polymers, and mixtures thereof.

6. The offset printing apparatus of claim 6, wherein said reinforcer is a carbon reinforcer selected from the group consisting of carbon black, graphite, fluorinated carbon, and mixtures thereof.

7. The offset printing apparatus of claim 1, wherein said polymer matrix further comprises a second additive, wherein said second additive is a filler selected from the group consisting of a metals, metal oxides, doped metal oxides, and mixtures thereof.

8. The offset printing apparatus of claim 7, wherein said filler is selected from the group consisting of titanium dioxide, tin (II) oxide, aluminum oxide, indium-tin oxide, magnesium oxide, copper oxide, iron oxide, silica or silicon oxide, and mixtures thereof.

9. The offset printing apparatus of claim 1, wherein said phase change ink is solid at about 25° C.

10. The offset printing apparatus of claim 1, wherein a heating member is associated with said imaging member.
